(19) United States
(12) Patent Application Publication
(10) Pub. No.: US 2025/0200455 A1
(43) Pub. Date: Jun. 19, 2025

(54) PROJECT MANAGEMENT TOOL INTEGRATED WITH ARTIFICIAL INTELLIGENCE CHATBOT

(71) Applicant: SAP SE, Walldorf (DE)

(72) Inventor: Showkath Ali Naseem, Anantapur (IN)

(21) Appl. No.: 18/539,796

(22) Filed: Dec. 14, 2023

(51) Int. Cl. G06Q 10/0631; G06F 40/40

(52) U.S. Cl. CPC G06Q 10/0631; G06F 40/40

(57) ABSTRACT

A first application receives a first query from a first user interface of a user device. The first application conveys the first query to a first external service in accordance with a first application programming interface. In an example, the first external service is an artificial intelligence chatbot. The first application receives first data from the first external service in response to the first query. The first application generates, based on the first data, a second query and conveys the second query to a second external service in accordance with a second application programming interface. In an example, the second external service is a project management tool. The first application receives second data from the second external service in response to the second query, and the first application incorporates the second data into a second user interface which is generated and displayed on the user device.

### TECHNICAL FIELD

The present disclosure generally relates to integrating artificial intelligence chatbots with project management tools.

### BACKGROUND

JIRA, by Atlassian, is a popular project management tool used by many organizations worldwide. ChatGPT is an advanced language model designed and developed by OpenAI that can understand natural language and generate human-like responses. ChatGPT has become a versatile tool that is widely used in various industries, including sales, human resources (HR), marketing, finances, recruitment operations, administration, production, public relations, and purchasing. ChatGPT offers a range of significant advantages, including the ability to perform a variety of tasks. These tasks include generating emails, creating knowledge base articles, learning new concepts, answering questions, transforming data into specific formats, generating test cases, providing source code support, and preparing product descriptions, user guides, resumes based on a given skill set, automating the processing of insurance claims, and so on. Additionally, ChatGPT can assist with summarizing documents, creating social media posts, resolving customer support inquiries, generating personalized ad copy with special offers, and even generating creative writing pieces such as poems and short stories.

### SUMMARY

In some implementations, a first application receives a first query from a first user interface of a user device. The first application conveys the first query to a first external service in accordance with a first application programming interface. In an example, the first external service is an artificial intelligence chatbot. The first application receives first data from the first external service in response to the first query. The first application generates, based on the first data, a second query and conveys the second query to a second external service in accordance with a second application programming interface. In an example, the second external service is a project management tool. The first application receives second data from the second external service in response to the second query, and the first application incorporates the second data into a second user interface which is generated and displayed on the user device.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a block diagram of a system, in accordance with some example implementations of the current subject matter;

FIG. 2 illustrates an example of a process of a user switching between multiple tools to perform various tasks, in accordance with some example implementations of the current subject matter;

FIG. 3 illustrates example of a Project Management AI Chatbot framework, in accordance with some example implementations of the current subject matter;

FIG. 4 illustrates an example of a GUI for interacting with the AI chatbot from the project management application, in accordance with some example implementations of the current subject matter;

FIG. 5 illustrates a diagram of an example process for integrating a Project Management Tracking tool with an AI Chatbot, in accordance with some example implementations of the current subject matter;

FIG. 6 illustrates an example of a process for integrating data from multiple applications and external services, in accordance with some example implementations of the current subject matter;

FIG. 7 illustrates an example of a process for integrating data from multiple applications and external services, in accordance with some example implementations of the current subject matter;

FIG. 8A depicts an example of a system, in accordance with some example implementations of the current subject matter; and

FIG. 8B depicts another example of a system, in accordance with some example implementations of the current subject matter.

### DETAILED DESCRIPTION

In an example, ChatGPT is integrated with JIRA, a project management tool, to create a bot that can perform various functions. This integration can help streamline the project management process, improve efficiency, and enhance productivity. With ChatGPT's advanced language capabilities and JIRA's powerful features, businesses can leverage this technology to achieve their objectives effectively. In other examples, other types of AI chatbots may be integrated with other types of project management tools. It should be understood that the descriptions of ChatGPT being integrated with JIRA are merely intended to serve as non-limited examples of the methods and mechanisms presented herein. These examples do not preclude the use of other types of AI tools, chatbot tools, project management tools, external services, and/or software applications.

One of the main challenges in project management is ensuring that tasks are well-defined and that user stories accurately reflect the requirements of the project. The definition of done (DoD) checklist is a critical part of Scrum methodology as it helps to ensure that user stories and sprints are completed to a high standard. However, creating a comprehensive DoD checklist can be time-consuming and challenging. Additionally, utilizing ChatGPT and JIRA to manage JIRA artifacts such as user stories, tasks, DoD checklist, and Documents through a manual standalone approach can lead to issues, which are explained further below.

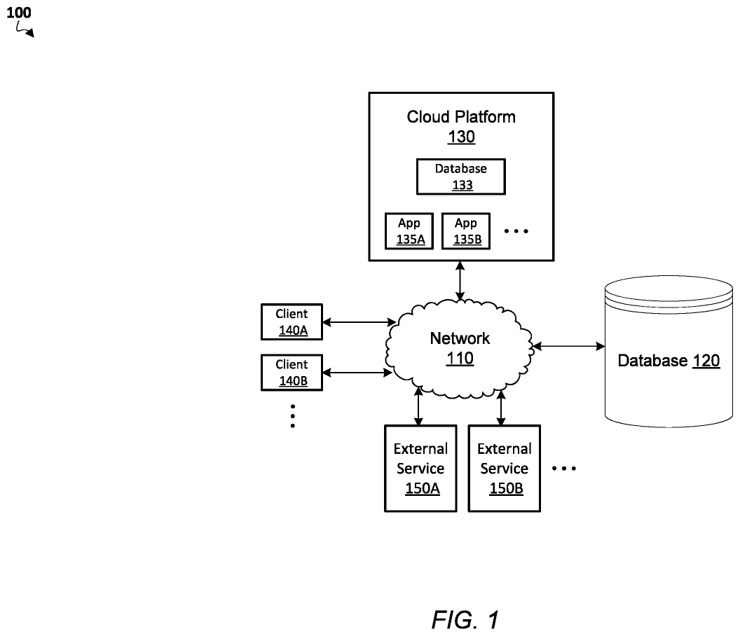

FIG. 1 depicts a diagram illustrating an example of a system 100 consistent with implementations of the current subject matter. Referring to FIG. 1, the system 100 may include a cloud platform 130. The cloud platform 130 may provide resources that can be shared among a plurality of tenants. For example, the cloud platform 130 may be configured to provide a variety of services including, for example, software-as-a-service (SaaS), platform-as-a-service (PaaS), infrastructure as a service (IaaS), and/or the like, and these services can be accessed by one or more tenants of the cloud platform 130. In the example of FIG. 1, the system 100 includes a first tenant 140A (labeled client) and a second tenant 140B (labeled client as well), although system 100 may include any number of other tenants. For example, multitenancy enables multiple end-user devices (e.g., a computer including an application) as well as multiple subscribing customers having their own group of end-users with an isolated context of the particular customers to access a given cloud service having shared resources via the Internet and/or other type of network or communication link(s).

The cloud platform 130 may include resources, such as at least one computer (e.g., a server), data storage, and a network (including network equipment) that couples the computer(s) and storage. The cloud platform 130 may also include other resources, such as operating systems, hypervisors, and/or other resources, to virtualize physical resources (e.g., via virtual machines) and provide deployment (e.g., via containers) of applications (which provide services, for example, on the cloud platform, and other resources). In the case of a “public” cloud platform, the services may be provided on-demand to a client, or tenant, via the Internet. For example, the resources at the public cloud platform may be operated and/or owned by a cloud service provider (e.g., Amazon Web Services, Azure), such that the physical resources at the cloud service provider can be shared by a plurality of tenants. Alternatively, or additionally, the cloud platform 130 may be a “private” cloud platform, in which case the resources of the cloud platform 130 may be hosted on an entity's own private servers (e.g., dedicated corporate servers operated and/or owned by the entity). Alternatively, or additionally, the cloud platform 130 may be considered a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

In various embodiments, the cloud platform 130 provides services to client 140A-B. Each service may be deployed via a container, which provides a package or bundle of software, libraries, and configuration data to enable the cloud platform to deploy during runtime the service to, for example, one or more virtual machines that provide the service to client 140A. The service may also include logic (e.g., instructions that provide one or more steps of a process) and an interface. The interface may be implemented as an Open Data Protocol (OData) interface (e.g., HTTP message may be used to create a query to a resource identified via a URI), although the interface may be implemented with other types of protocols including those in accordance with REST (Representational state transfer).

In the example of FIG. 1, there are two databases 133 and 120, although other quantities of databases may be implemented as well. The first database 133 is internal to the cloud platform 130, but the second database 120 is external to the cloud platform 130, so an external REST type call may be used to send queries and receive responses from database 120. For example, when the interface is configured in accordance with REST or the ODATA protocol, the interface may access a data model, such as the client tenant schema associated with client 140A's data at database 120. And, the interface may provide a REST or Open Data Protocol (ODATA) interface to external applications and/or services, which in this case is the database 120. In the case of REST compliant interfaces, the interface may provide a uniform interface that decouples the client and server, is stateless (e.g., a request includes all information needed to process and respond to the request), cacheable at the client side or the server side, and the like.

Cloud platform 130 is coupled to external services 150A-150B, which are representative of any number and type of external services, such as a software as a service, a platform as a service, and so on. In an example, external service 150A is a project management service such as JIRA, external service 150B is an artificial intelligence chatbot such as ChatGPT, and so on. In other examples, external services 150A-150B may be other types of services and/or tools which are external to cloud platform 130.

To illustrate further, the client 140A may cause execution of a process or job on application 135A or application 135B. Applications 135A-B are representative of any number and type of applications running on cloud platform 130. In an example, an action or a condition at client 140A may cause a message querying or requesting a response from application 135A. If the response from application 135A requires a query to the database 120 or one or more of external services 150A-B in order to obtain data associated with the query, a REST call may be made to database 120 or external services 150A-B. Application 135A may receive a response to the query from the database 120 and/or from external services 150A-B. The response may be compliant with REST as well. At least a portion of the noted process may execute at the cloud platform 130 (although a portion may execute at the client 140A as well). Alternatively, or additionally, the noted process may include a service extension. The service extension may represent a modification in the process (e.g., added step(s) and/or deleted step(s)) specific to, or uniquely for, the client 140A. In other words, the service extension may customize at least a portion of the process for the client 140A.

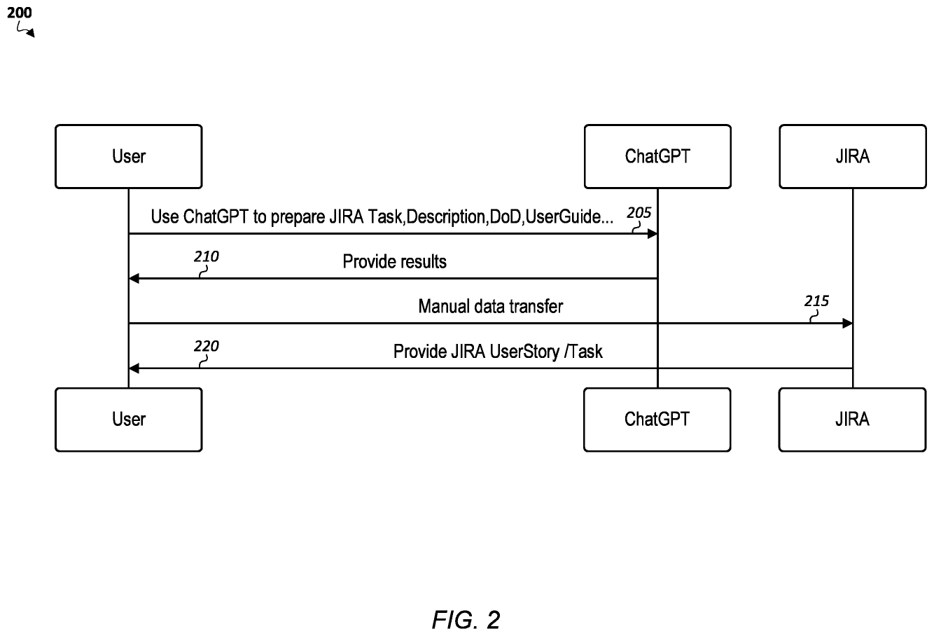

Turning now to FIG. 2, an example of a process 200 of a user switching between multiple tools to perform various tasks is shown. Process 200 illustrates an approach where a user needs to switch between multiple tools to perform various tasks, leading to a fragmented user experience. For example, a user may login in to ChatGPT and connect to ChatGPT in step 205 for preparation of a JIRA task, description, definition of done (DoD), user guide, and so on. ChatGPT may provide the results to the user in step 210. Then, the user may login to JIRA (requiring a separate login different from the ChatGPT login) and manually transfer data in step 215. JIRA may provide the user story, task, and other data back to the user in step 220. It should be understood that ChatGPT and JIRA are representative of any type of AI chatbots and project management tools, respectively, that may be employed by a user for process 200.

In the approach shown in process 200 of FIG. 2, the user needs to switch between the ChatGPT and JIRA tools, which leads to a fragmented user experience. The data transfer between the tools is manual and prone to errors, leading to inconsistencies in the data. Additionally, it is inadvisable to enter business sensitive data into open source tools. Managing data privacy and security is a reactive process, with threats detected only after they have occurred. For the user to provide business sensitive data directly to external tools is taking a risk that the business sensitive data may be compromised or shared with third parties.

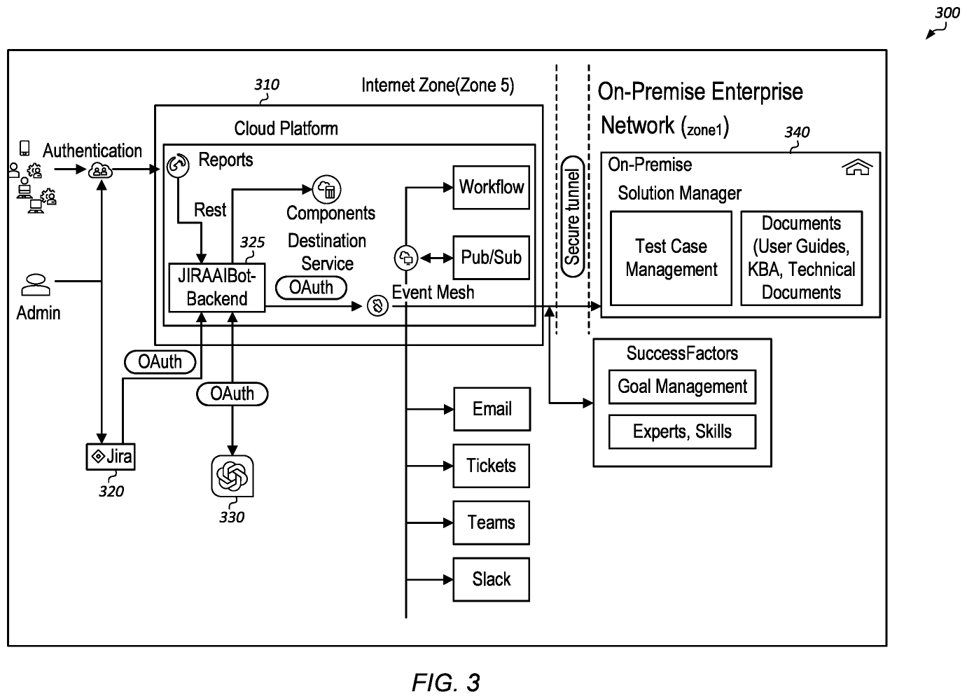

In contrast to the approach of process 200 shown in FIG. 2, the Project Management AI Chatbot framework 300 shown in FIG. 3 does not require separate logins or data transfer between tools. The JIRA AI ChatGPT BOT 325 presented in FIG. 3 is a powerful tool that can help teams manage projects more effectively, improve quality and productivity, and enhance customer satisfaction. In an example, Project Management AI Chatbot framework 300 includes cloud platform 310, external service 320, JIRA AI ChatGPT BOT 325, external service 330, and on-premise solution manager 340. In an example, external service 320 is JIRA and external service 330 is ChatGPT. However, in other examples, external service 320 and external service 330 may be other types of platforms and/or services. It is noted that JIRA AI ChatGPT BOT 325 is labeled as JIRAAIBot-Backend in FIG. 3. It is also noted that JIRA AI ChatGPT BOT 325 may also be referred to more generally as an integrated chatbot.

Using machine learning & NLP (natural language processing) from ChatGPT or Azure Open AI Integration with JIRA, JIRA AI ChatGPT BOT 325 may analyse user stories and task descriptions and provide suggestions for improvement. For example, the JIRA AI ChatGPT BOT 325 may identify ambiguous language, incomplete requirements, or inconsistencies in descriptions. With its advanced features and integration with JIRA, the integrated chatbot can provide significant business value to organizations and Agile Teams of all sizes.

The integration of ChatGPT and JIRA into the JIRA AI ChatGPT BOT 325 enables businesses to leverage the capabilities of AI-powered language processing and advanced project management tools to improve data privacy and security. The JIRA AI ChatGPT BOT 325 enables the combination of the JIRA and ChatBot tools and integrates these tools with other channels such as ITDirect, Email, Support, Reporting tools such as SAP SAC as available from SAP SE, Walldorf, Germany, Collaboration channels like Teams, Solution Management and SAP Employee Goal Management tools, and other tools.

In an example, ChatGPT and JIRA are integrated together into JIRA AI ChatGPT BOT 325 to create a unified solution for data privacy and security management. The JIRA AI ChatGPT BOT 325 uses AI-powered language processing to monitor data and detect potential data privacy and security threats proactively. The integration of ChatGPT and JIRA into JIRA AI ChatGPT BOT 325 enables businesses to take a more proactive approach to data privacy and security management, enabling businesses to respond quickly and efficiently to potential threats. Users can access both tools from a single platform, simplifying the user experience and reducing the need for manual data transfer. Furthermore, the JIRA AI ChatGPT BOT 325 has the capability to provide suggestions for experts, ticket categories, test cases, and user guides. JIRA AI ChatGPT BOT 325 also has the ability to generate technical documents for JIRA. Overall, the integration of ChatGPT and JIRA into JIRA AI ChatGPT BOT 325 provides a more intelligent and proactive approach to managing data privacy and security, enabling businesses to protect their sensitive information from potential security breaches.

Integrating Azure OpenAI ChatGPT and JIRA in JIRA AI ChatGPT BOT 325 offers several advantages compared to using these tools individually. This integrated solution provides benefits in areas such as data privacy and security, user experience, and seamless integration. By integrating ChatGPT and JIRA in JIRA AI ChatGPT BOT 325, businesses can ensure compliance with data privacy regulations and prevent unauthorized data disclosure, especially outside secure corporate environments. The integrated chatbot provides a more centralized and cohesive approach to managing data privacy and security, thereby reducing the risk of potential security breaches and ensuring data integrity. This enables businesses to monitor, detect, and respond to potential data privacy and security threats quickly and efficiently.

The JIRA AI ChatGPT BOT 325 offers a more intuitive and user-friendly interface that is easy to navigate and interact with. The integration of ChatGPT and JIRA in the JIRA AI ChatGPT BOT 325 allows users to access both tools from a single platform, simplifying the user experience and reducing the need for users to switch between multiple tools. The integration of ChatGPT and JIRA in the JIRA AI ChatGPT BOT 325 also offers greater flexibility for agile teams by allowing them to access ChatGPT within the JIRA environment. This can improve productivity and streamline project management process.

In an example, using the JIRA AI ChatGPT BOT framework 300 to integrate ChatGPT within JIRA, the process of generating JIRA artifacts such as User Stories may be streamlined. Without this integration, team members would need to switch between multiple tools and manually input information, which can be time-consuming and prone to errors. By automating this process with ChatGPT integrated within JIRA, significant time can be saved and reduce the risk of errors can be reduced, thereby lowering operational costs.

In an example, using the JIRA AI ChatGPT BOT framework 300 to integrate ChatGPT within JIRA may reduce maintenance costs. Maintaining multiple tools can be costly, as it requires regular updates and maintenance. By integrating ChatGPT within JIRA using the JIRA AI ChatGPT BOT framework 300, the number of tools a team needs to maintain is reduced, lowering maintenance costs. Overall, integrating ChatGPT within JIRA using the JIRA AI ChatGPT BOT framework 300 can offer a more cost-effective solution for accessing ChatGPT compared to using these tools separately. Also, integrating ChatGPT within JIRA using the JIRA AI ChatGPT BOT framework 300 streamlines the project management process.

Additionally, the JIRA AI ChatGPT BOT 325 provides businesses with a scalable and flexible solution that can adapt to changing business needs. In large organizations, it can be challenging to find the right team or expert who can manage a project management tool. The JIRA AI ChatGPT BOT 325 may help in finding experts who are suitable for JIRA-related work. Additionally, the JIRA AI ChatGPT BOT may auto-suggest the appropriate JIRA Ticket Category, which reduces the time required to create tickets and ensures that the tickets are correctly categorized. Finally, integration with Employee Goal Management tools such as SuccessFactors (by SAP) provides a more comprehensive and efficient solution compared to using standalone tools. This integration helps organizations in managing their employees' goals efficiently and effectively.

Overall, the JIRA AI ChatGPT BOT 325 provides a more streamlined and efficient solution for JIRA-related work, which may ultimately lead to increased productivity and better management of employees' goals. By leveraging the capabilities of the integration of ChatGPT and JIRA, collaboration channels like Teams, IT Direct Support System, and SuccessFactors provide businesses with a scalable and flexible solution that can adapt to changing business needs.

A unified, cloud-based platform (e.g., cloud platform 130 of FIG. 1) allows customers to develop, integrate, and extend their business applications, processes, and services. Users may utilize a cloud platform to connect to various systems such as Success Factor, JIRA, Azure OpenAI ChatGPT, ITSupport System, and other systems and tools. Other tools include React which is a JavaScript library for building user interfaces. React can be used to build web-based chatbots and conversational interfaces, and React can be integrated with other technologies and frameworks to build more complex applications and integrations. Atlassian Forge is a cloud development platform that provides a set of tools and application programming interfaces (APIs) for building apps and integrations for Atlassian products like Jira, Confluence, and Bitbucket without worrying about the infrastructure.

The following is a brief overview of how to build a user interface (UI) using Forge UI and the Forge API. First, a development environment is setup. To build Forge apps, a development environment is setup with the Forge command-line interface (CLI), which can be installed using npm. A new Forge app project may be created and connected to an Atlassian account. Next, a UI approach may be chosen. As per Forge Document, there are two options for designing the UI of Forge app: Custom UI and the UI kit. Custom UI allows the user to create standalone React apps that can be hosted on the Forge platform, while the UI kit provides pre-built Atlassian components for simpler apps. Use the Forge UI library: If the user chooses to use Custom UI, the user can use the Forge UI library to create the app's user interface. The library includes a range of UI components, such as forms, buttons, and dropdown menus, that the user can use to build the app's interface. Use the Forge API: To interact with the Atlassian platform and access data from Jira or Confluence, the user will need to use the Forge API. The API provides a range of endpoints for accessing data and performing actions, such as creating issues or updating pages. Test and deploy app: Once the user has built their app's UI and integrated it with the Forge API, the user can test it locally using the Forge CLI. Once the user is satisfied with the app, the user can deploy it to the Atlassian marketplace for others to use.

Other environments and frameworks include Node.js which is a server-side JavaScript runtime environment that allows users to build scalable and performant web applications. Express.js is a popular Node.js web framework that provides a set of features for building web applications and APIs. Axios is a JavaScript library that provides an easy-to-use API for making HTTP requests from Node.js or browser-based applications. Azure OpenAI API is a set of language models and APIs that provide natural language processing capabilities, including text generation, question-answering, and language translation.ChatGPT is now available in Microsoft Azure OpenAI Service.

The JIRA AI ChatGPT BOT 325 can provide a wide range of features to assist project teams in various aspects of project management. From automatic creation of JIRA tasks and personas to creating technical and end user documentation, test cases, and automated test scripts, the integrated chatbot may streamline and simplify many aspects of the project management process. Additionally, the JIRA AI ChatGPT BOT 325 may assist with Jira Query Language (JQL) queries and generate reports, enabling teams to make data-driven decisions and track project progress effectively.

The JIRA AI ChatGPT BOT 325 enables the automatic Creation of JIRA Tasks Description, Personas, and Scenarios. The JIRA AI ChatGPT BOT 325 may use natural language processing to analyze the subject of a task and automatically generate a task description, as well as create all possible personas and scenarios related to the task. This can save a lot of time and effort for project managers and teams, as it eliminates the need to manually create these elements. The JIRA AI ChatGPT BOT 325 may also be used for automated JIRA reporting. For example, the JIRA AI ChatGPT BOT 325 may generate JIRA reports based on user queries in natural language. This feature can provide teams with quick and easy access to important project metrics and insights, helping them to make data-driven decisions.

The JIRA AI ChatGPT BOT 325 may also be used for the creation of technical and end user documentation. In an example, the JIRA AI ChatGPT BOT 325 may assist with the creation of technical documentation for a user story, as well as end user documentation for a feature. This can help to ensure that project stakeholders have the information they need to understand and use the product effectively. Additionally, the JIRA AI ChatGPT BOT 325 may create test cases based on user stories, ensuring that all functionality is properly tested and meets the requirements of the project. The JIRA AI ChatGPT BOT 325 may also be used to create Definition of Done (DoD) checklists for user stories. For example, the JIRA AI ChatGPT BOT 325 may help teams to create comprehensive DoD checklists for user stories, ensuring that all tasks are completed to a high standard and meet the requirements of the project.

The JIRA AI ChatGPT BOT 325 may also assist with the creation of automated test scripts, which can help to streamline the testing process and improve the efficiency of the project. The JIRA AI ChatGPT BOT 325 may help users to write JQL queries by providing suggestions and guidance on syntax and structure. This can help teams to quickly and easily find the information they need in JIRA. The JIRA AI ChatGPT BOT 325 allows users to customize chatbot responses to meet their specific needs. Other advantages include multilingual support and personalization. For example, the JIRA AI ChatGPT BOT 325 supports multiple languages to enable global communication and collaboration. The JIRA AI ChatGPT BOT 325 also enables users to personalize their chatbot experience. For example, users are allowed to choose their preferred language, interface, or communication style.

Other advantages of the JIRA AI ChatGPT BOT 325 include using predictive analytics to suggest improvements for project management tasks, incorporating voice recognition technology for easier interaction with the chatbot, and integrating with other project management tools such as GitHub, Successfactors, and ITDirect Ticket APP to provide a more complete solution. Additionally, JIRA AI ChatGPT BOT 325 allows users to access their chat history with the chatbot, find information, and review past interactions with the chatbot. JIRA AI ChatGPT BOT 325 also supports human handover functionality. For example, JIRA AI ChatGPT BOT 325 may recognize when a question or issue requires human intervention and hand over the interaction to a live support agent. JIRA AI ChatGPT BOT 325 may also provide detailed reports and insights on chatbot usage and performance to help teams make data-driven decisions.

It is noted that the JIRA AI ChatGPT BOT 325 may also be referred to more generally as an integrated AI chatbot project management tool or as an integrated project management AI chatbot tool. Here are a few example questions that may be provided as inputs to the integrated AI chatbot project management tool: Based on the subject, can you automatically create a JIRA User Story Description with all possible scenarios and personas? Based on the subject, can you automatically create a JIRA User Story Description with all possible scenarios, personas, test cases, Definition of Done (DoD)? Can you create technical documentation for a user story? Can you create end user documentation for a feature? Can you help me create a Definition of Done (DoD) checklist for a user story? Can you assist me in creating personas for my project? What is the process for creating test cases in JIRA? How can I create automated test cases and test scripts in JIRA? What is the process for creating JIRA tasks descriptions based on different scenarios and personas?

Here are few examples of how the JIRA AI ChatGPT BOT 325 can be used for real-time projects or user stories: Real-time project example: A software development company is building a new e-commerce platform for a client. The development team can use the JIRA AI ChatGPT BOT 325 to create technical documentation for the user story “As a customer, I want to be able to add items to my shopping cart.” The integrated chatbot can generate a technical document detailing the necessary functionality and requirements for the shopping cart, which the development team can then use to build the feature. User story example: “As a user, I want to be able to search for products on the e-commerce platform.” The Product Owner can use JIRA AI ChatGPT BOT 325 to automatically create a JIRA User Story Description with all possible scenarios and personas. The integrated chatbot can generate a detailed user story description that includes different search scenarios and user personas, such as a first-time user, a returning user, and a power user. This can help ensure that the development team has a clear understanding of the user story and can build the necessary functionality.

Real-time project example: A marketing agency is building a new website for a client. The development team can use JIRA AI ChatGPT BOT 325 to create test cases and automated test scripts for the user story: “As a website visitor, I want to be able to submit a contact form.” The integrated chatbot can generate test cases that include different scenarios, such as submitting the form with all the required fields filled out, submitting the form with missing required fields, and submitting the form with invalid data. The integrated chatbot can also generate automated test scripts to ensure that the form works correctly and that the data is submitted.

Here are some examples of different Personas: During a sprint planning meeting, the Scrum Master can use the JIRA AI ChatGPT BOT 325 to automatically create descriptions for JIRA tasks based on the subject of the tasks. This can save time for the Scrum Master and ensure that all relevant information is included in the task description. The Product Owner can use the JIRA AI ChatGPT BOT 325 to create technical documentation for a user story. This can help ensure that the development team has a clear understanding of the technical requirements and can create the necessary functionality. The Business Owner can use the JIRA AI ChatGPT BOT 325 to create end user documentation for a feature. This can help ensure that end-users have a clear understanding of how to use the feature and can improve the overall user experience. The Product Manager can use the JIRA AI ChatGPT BOT 325 to create a Definition of Done (DoD) checklist for a user story. This can help ensure that all the necessary criteria are met before a user story is considered complete. The development team can use the JIRA AI ChatGPT BOT 325 to create test cases and automated test scripts. This can help ensure that the software is thoroughly tested and meets the necessary requirements before it is released. By utilizing JIRA AI ChatGPT BOT 325, project management teams can streamline their processes, save time, and improve overall efficiency.

Some of the advantages of utilizing JIRA AI ChatGPT BOT include, but are not limited to: Quality of user stories and task descriptions: The JIRA AI ChatGPT BOT 325 can provide significant value to teams by improving the quality of user stories and task descriptions. This can lead to more accurate project planning, better task management, and improved project outcome. Providing Suggestions: The JIRA AI ChatGPT BOT 325 can be particularly useful for teams that are new to project management or that have limited experience with writing user stories and task descriptions. By providing guidance and suggestions for improvement, the integrated chatbot can help teams to create more accurate and comprehensive descriptions, which can in turn lead to better project outcomes. Assist in creating definition of done (DoD): The JIRA AI ChatGPT BOT 325 can help to simplify this process by providing guidance and suggestions for creating DoD checklists for user stories and sprints. By analyzing the requirements of the project and using machine learning algorithms, the integrated chatbot can provide suggestions for key elements that should be included in the DoD checklist.

In an example, the JIRA AI ChatGPT BOT 325 can help to ensure consistency across user stories and task descriptions by suggesting standardization and best practices for the DoD checklist. By analyzing multiple descriptions and identifying common elements, the integrated chatbot can suggest standardization and best practices, which can help to improve the overall quality of project management and ensure that all user stories and sprints are completed to the same high standard. By automating common tasks and providing assistance, the integrated chatbot can help teams work more efficiently and increase productivity. With 24/7 availability and quick response times, the integrated chatbot can improve customer satisfaction by providing fast and helpful support.

By automating tasks and reducing the need for human support, the integrated chatbot can help organizations save money and reduce total cost of ownership (TCO). The JIRA AI ChatGPT BOT 325 offers several advantages for management in the realm of project management. The integrated chatbot streamlines task management and tracking in real-time, allowing managers to monitor project progress and identify potential issues quickly. The integrated chatbot provides performance metrics and analytics, enabling data-driven decision-making and the ability to identify areas for improvement. The integrated chatbot also helps with resource, risk, and budget management, making it easier to allocate resources and mitigate risks. Additionally, the integrated chatbot facilitates effective communication and collaboration with team members and stakeholders, ensuring that everyone is on the same page. Still further, the integrated chatbot offers customized reporting and access control for improved project oversight, providing managers with the tools they need to successfully manage their teams and projects. Overall, the JIRA AI ChatGPT BOT 325 can provide significant value and advantages to different roles involved in the project management process, helping agile teams to better manage projects, collaborate with team members and stakeholders, and make informed decisions based on real-time data and insights.

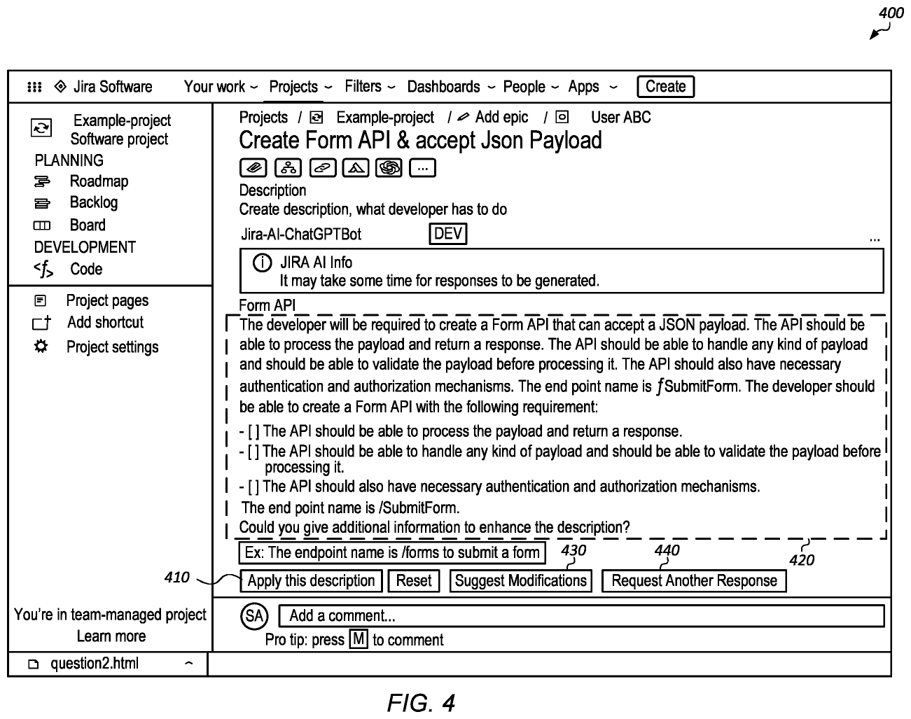

Turning now to FIG. 4, an example of a graphical user interface (GUI) 400 for interacting with an AI chatbot from a project management application is shown, in accordance with some example implementations of the current subject matter. In an example, a user may enter a query such as “Create Form API”. This query may be forwarded by the framework (e.g., framework 300 of FIG. 3) to an AI chatbot.

The text in dashed box 420 is an example of text that may be generated by the AI chatbot in response to receiving the “Create Form API” query. In other examples, other text may be generated by the AI chatbot in response to receiving the “Create Form API” query. If the user is not satisfied with the text generated by the AI chatbot, then the user may request that the AI chatbot regenerate the text by selecting graphical element 440 labeled “Request Another Response”. The user may also provide one or more indications of what portions of the text did not meet their expectations by selecting graphical element 430 labeled “Suggest Modifications”. Several iterations may be executed until the user is satisfied. Additionally, the user may enhance the description by adding additional text or modifying the existing text.

Once the user is satisfied with the text, the user may click on graphical element 410, labeled “Apply this description”, and then the text returned from the AI chatbot (with any additional enhancements provided by the user) will be integrated into the project management application. It should be understood that the example of GUI 400 is merely indicative of the text that is generated for a particular type of query, such as the user requesting “Create Form API”. Other types of queries may be generated in other embodiments, and other suitable text may be generated by the AI chatbot in response to these queries. It is noted that “graphical elements” may also be referred to as “buttons” or “boxes”.

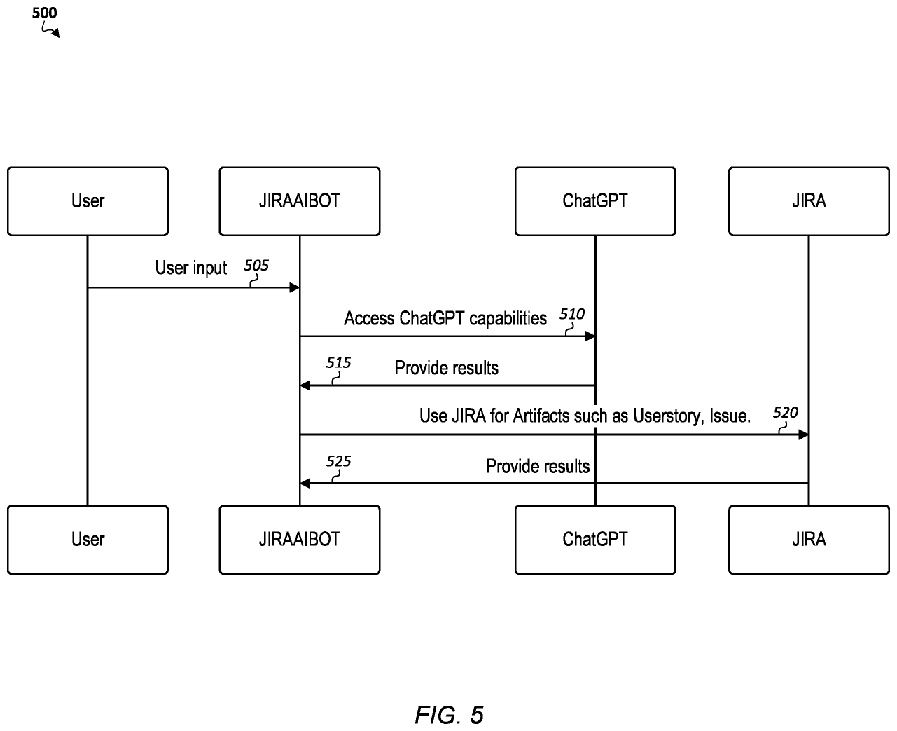

Referring now to FIG. 5, a diagram 500 of an example process for integrating a Project Management Tracking tool with an AI Chatbot is shown, in accordance with some example implementations of the current subject matter. In step 505, the user provides an input query to the integrated Project Management Tracking AI Chatbot tool. In an example, the integrated Project Management Tracking AI Chatbot tool is referred to as a JIRA-AI-BOT application (or “JIRAAIBOT” in the boxes of diagram 500). In other examples, other Project Management Tracking tools other than JIRA may be utilized in the integrated Project Management Tracking AI Chatbot tool.

In response to receiving the input query, the JIRA-AI-BOT application accesses ChatGPT in step 510. In response to the access, ChatGPT provides results to the input query in step 515. Additionally, the JIRA-AI-BOT application sends a request to JIRA for artifacts such as user story description management, test cases, definition of done (DoD), user guide, and so on in step 520. In response to the request from the JIRA-AI-BOT application, JIRA provides results back to the JIRA-AI-BOT application in step 525.

While examples may be given herein of integrating JIRA with ChatGPT, it should be understood that this is merely for the purposes of illustration. These examples do not preclude the employment of other tools besides just JIRA and ChatGPT. In other embodiments, other types of project management tools may be integrated with other types of AI chatbots. In other words, the methods and mechanisms described herein may be utilized with any of various types of project management tools and AI chatbots.

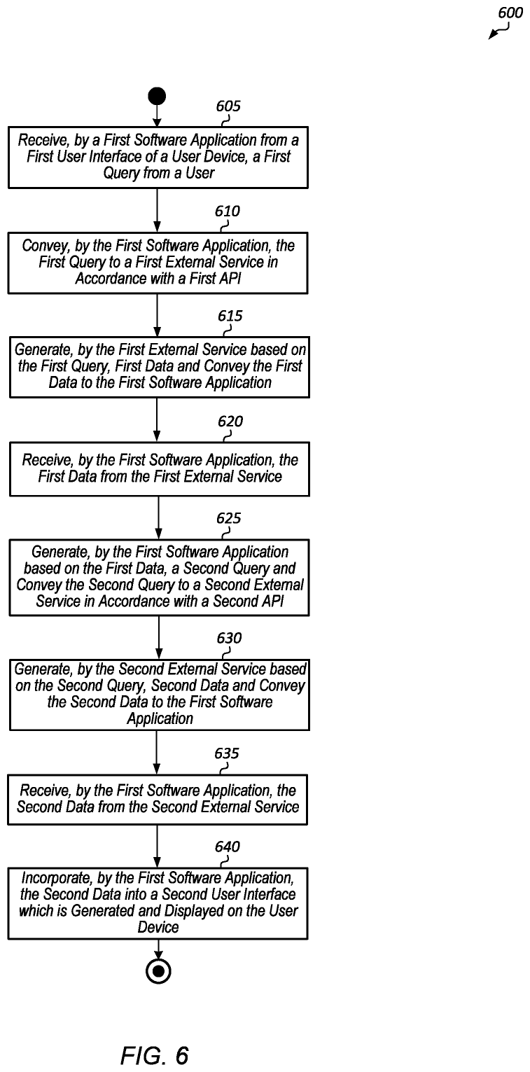

Turning now to FIG. 6, a process for integrating data from multiple applications and services is shown, in accordance with some example implementations of the current subject matter. A first software application receives, from a first user interface of a user device, a first query from a user (block 605). In an example, the first software application (e.g., application 135A of FIG. 1) is hosted by a cloud platform (e.g., cloud platform 130). The first query may be any of various types of queries. A listing of example types of queries that may be generated by a user includes, but is not limited to, the following: (1) Based on the subject, can you automatically create a JIRA User Story Description with all possible scenarios and personas? (2) Based on the subject, can you automatically create a JIRA User Story Description with all possible scenarios, personas, test cases, Definition of Done (DoD)? (3) Can you create technical documentation for a user story? (4) Can you create end user documentation for a feature? (5) Can you help me create a Definition of Done (DoD) checklist for a user story? (6) Can you assist me in creating personas for my project? (7) What is the process for creating test cases in JIRA? (8) How can I create automated test cases and test scripts in JIRA? (9) What is the process for creating JIRA tasks descriptions based on different scenarios and personas? (10) Create Form API. Other types of queries that may be generated by a user, besides those presented herein, are possible and are contemplated.

In response to receiving the first query, the first software application conveys the first query to a first external service in accordance with a first application programming interface (API) (block 610). In an example, the first external service is an artificial intelligence (AI) chatbot such as ChatGPT. It is noted that the term “external service” may also be referred to herein as an external tool, as an external platform, as a platform tool, or as a platform function. As used herein, the term “external service” may be defined as service or platform external to a cloud platform hosting a software application, where the service or platform requires a separate set of login credentials from the cloud platform hosting the software application. The “external service” may be a software as a service, a platform as a service, or the like.

Next, the first external service generates, based on the first query, first data and conveys the first data to the first software application in response to receiving the first query from the first software application (block 615). Then, the first software application receives the first data from the first external service (block 620). Next, the first software application generates, based on the first data, a second query and conveys the second query to a second external service in accordance with a second API (block 625). In an example, the second external service is a program management platform or tool such as JIRA.

Then, the second external service generates, based on the second query, second data and conveys the second data to the first software application (block 630). Next, the first software application receives the second data from the second external service (block 635). Then, the first software application incorporates the second data into a second user interface which is generated and displayed on the user device (block 640). After block 640, method 600 ends.

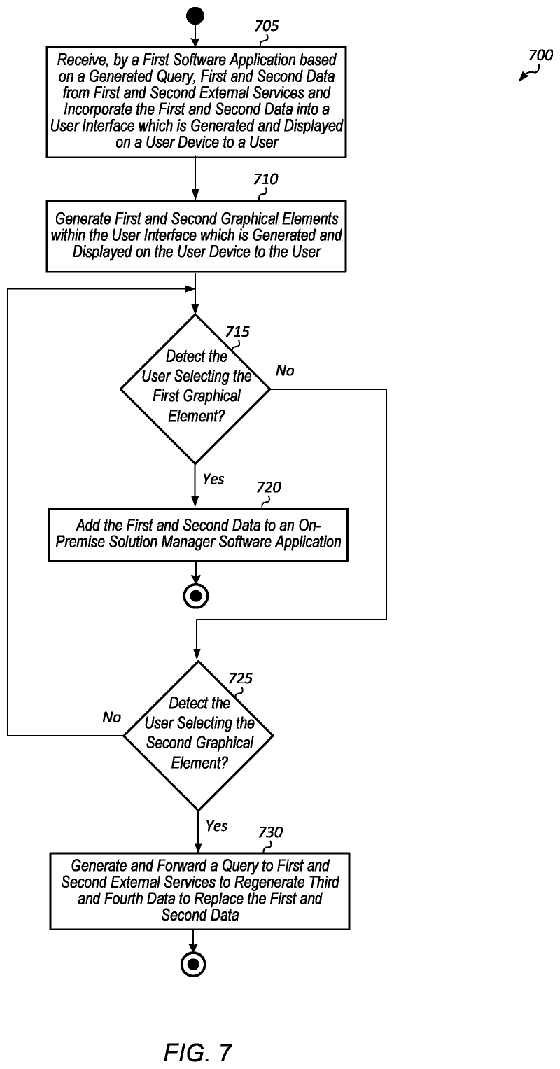

Referring now to FIG. 7, a process for integrating data from multiple applications and external services is shown, in accordance with some example implementations of the current subject matter. A first software application receives, based on a query, first and second data from first and second external services, respectively, and incorporates the first and second data into a user interface which is generated and displayed on a user device to a user (block 705). In an example, block 705 may be performed by implementing method 600 of FIG. 6. The first software application generates first and second graphical elements within the user interface which is generated and displayed on the user device to the user (block 710). In an example, the first graphical element is graphical element 410 of FIG. 4 and the second graphical element is graphical element 440 of FIG. 4. It is noted that the first software application may also generate a third graphical element (e.g., graphical element 430), a fourth graphical element, and so on within the user interface.

If the first software application detects the user selecting (i.e., clicking on) the first graphical element (conditional block 715, “yes” leg), then the first and second data are added to an on-premise solution manager software application (e.g., on-premise solution manager 340 of FIG. 3) (block 720). If the first software application detects the user selecting the second graphical element (conditional block 725, “yes” leg), then the first software application generates a query, based on the selection of the second graphical element, and the first software application forwards the query to first and second external services to cause third and fourth data to be regenerated to replace the first and second data (block 730). If the first software application does not detect the user selecting the second graphical element (conditional block 725, “no” leg), then method 700 returns to conditional block 715).

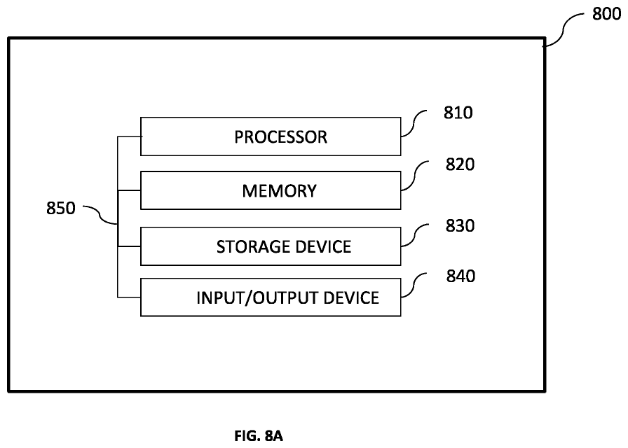

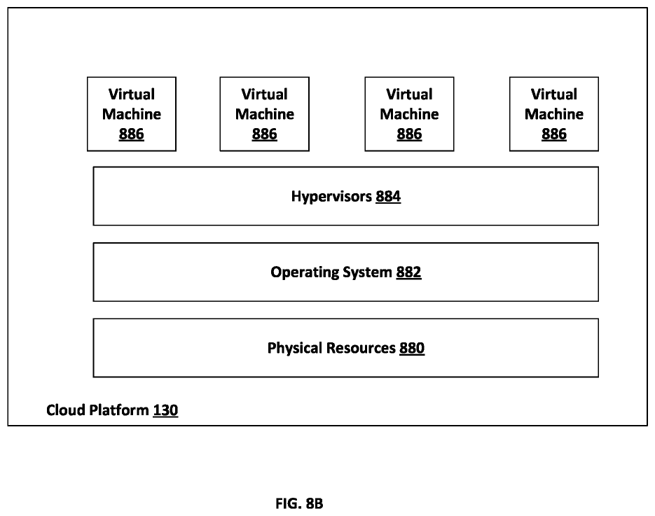

In some implementations, the current subject matter may be configured to be implemented in a system 800, as shown in FIG. 8A. The system 800 may include a processor 810, a memory 820, a storage device 830, and an input/output device 840. Each of the components 810, 820, 830 and 840 may be interconnected using a system bus 850. The processor 810 may be configured to process instructions for execution within the system 800. In some implementations, the processor 810 may be a single-threaded processor. In alternate implementations, the processor 810 may be a multi-threaded processor. The processor 810 may be further configured to process instructions stored in the memory 820 or on the storage device 830, including receiving or sending information through the input/output device 840. The memory 820 may store information within the system 800. In some implementations, the memory 820 may be a computer-readable medium. In alternate implementations, the memory 820 may be a volatile memory unit. In yet some implementations, the memory 820 may be a non-volatile memory unit. The storage device 830 may be capable of providing mass storage for the system 800. In some implementations, the storage device 830 may be a computer-readable medium. In alternate implementations, the storage device 830 may be a floppy disk device, a hard disk device, an optical disk device, a tape device, non-volatile solid state memory, or any other type of storage device. The input/output device 840 may be configured to provide input/output operations for the system 800. In some implementations, the input/output device 840 may include a keyboard and/or pointing device. In alternate implementations, the input/output device 840 may include a display unit for displaying graphical user interfaces.

FIG. 8B depicts an example implementation of a cloud platform 130 (of FIG. 1), which provides cloud services. The cloud platform 130 may be implemented using various physical resources 880, such as at least one hardware servers, at least one storage, at least one memory, at least one network interface, and the like. The cloud platform 130 may also be implemented using infrastructure, as noted above, which may include at least one operating systems 882 for the physical resources and at least one hypervisor 884 (which may create and run at least one virtual machine 886). For example, each multitenant application may be run on a corresponding virtual machine.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives program instructions as a machine-readable signal. The term “machine-readable signal” refers to any signal used to provide machine instructions and/or data to a programmable processor. The machine-readable medium can store such program instructions non-transitorily, such as for example as would a non-transient solid state memory or a magnetic hard drive or any equivalent storage medium. The machine-readable medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:
Example 1: A method performed by a computing system, comprising: receiving, by a first application, a first query from a first user interface of a user device; conveying the first query to a first external service in accordance with a first application programming interface; receiving first data from the first external service in response to the first query; generating, based on the first data, a second query and conveying the second query to a second external service in accordance with a second application programming interface; receiving second data from the second external service in response to the second query; and incorporating the second data into a second user interface generated and displayed on the user device.
Example 2: The method of Example 1, further comprising: generating a first graphical element as part of the first user interface; and incorporating the second data into the second user interface generated on the user device in response to a user selecting the first graphical element in the first user interface.
Example 3: The method of any of Examples 1-2, further comprising: generating a second graphical element as part of the first user interface; and conveying a third query to the first external service in response to a user selecting the second graphical element in the first user interface, wherein the third query comprises a request for one or more modifications to the first data.
Example 4: The method of any of Examples 1-3, further comprising conveying a fourth query to the second external service in response to receiving third data, based on the third query, from the first external service.
Example 5: The method of any of Examples 1-4, further comprising managing, by the first application, a second login into the first external service and a third login into the second external service for a user of the user device based on a first login of the user into the first application.
Example 6: The method of any of Examples 1-5, wherein the first data comprises one or more tasks, and wherein the second data comprises one or more user stories.
Example 7: The method of any of Examples 1-6, wherein the first external service is an artificial intelligence chatbot, and wherein the second external service is a project management tool.
Example 8: The method of any of Examples 1-7, wherein the first data comprises one or more test scripts, and wherein the second query comprises the one or more test scripts to be executed by the project management tool.
Example 9: The method of any of Examples 1-8, wherein the first data comprises a definition of done checklist for a user story.
Example 10: The method of any of Examples 1-9, wherein the first data comprises a technical document for a user story.
Example 11: A system, comprising: at least one processor; and at least one memory including program instructions which when executed by the at least one processor cause operations comprising: receiving, by a first application, a first query from a first user interface of a user device; conveying the first query to a first external service in accordance with a first application programming interface; receiving first data from the first external service in response to the first query; generating, based on the first data, a second query and conveying the second query to a second external service in accordance with a second application programming interface; receiving second data from the second external service in response to the second query; and incorporating the second data into a second user interface generated and displayed on the user device.
Example 12: The system of Example 11, wherein the program instructions are further executable by the at least one processor to cause operations comprising: generating a first graphical element as part of the first user interface; and incorporating the second data into the second user interface generated on the user device in response to a user selecting the first graphical element in the first user interface.
Example 13: The system of any of Examples 11-12, wherein the program instructions are further executable by the at least one processor to cause operations comprising: generating a second graphical element as part of the first user interface; and conveying a third query to the first external service in response to a user selecting the second graphical element in the first user interface, wherein the third query comprises a request for one or more modifications to the first data.
Example 14: The system of any of Examples 11-13, wherein the program instructions are further executable by the at least one processor to cause operations comprising conveying a fourth query to the second external service in response to receiving third data, based on the third query, from the first external service.
Example 15: The system of any of Examples 11-14, wherein the program instructions are further executable by the at least one processor to cause operations comprising managing, by the first application, a second login into the first external service and a third login into the second external service for a user of the user device based on a first login of the user into the first application.
Example 16: The system of any of Examples 11-15, wherein the first data comprises one or more tasks, and wherein the second data comprises one or more user stories.
Example 17: The system of any of Examples 11-16, wherein the first external service is an artificial intelligence chatbot, and wherein the second external service is a project management tool.
Example 18: The system of any of Examples 11-17, wherein the first data comprises one or more test scripts, and wherein the second query comprises the one or more test scripts to be executed by the project management tool.
Example 19: The system of any of Examples 11-18, wherein the first data comprises a definition of done checklist for a user story.
Example 20: A non-transitory computer readable medium storing instructions, which when executed by at least one data processor, cause operations comprising: receiving, by a first application, a first query from a first user interface of a user device; conveying the first query to a first external service in accordance with a first application programming interface; receiving first data from the first external service in response to the first query; generating, based on the first data, a second query and conveying the second query to a second external service in accordance with a second application programming interface; receiving second data from the second external service in response to the second query; and incorporating the second data into a second user interface generated and displayed on the user device.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A method performed by a computing system, comprising:
receiving, by a first application, a first query from a first user interface of a user device;
conveying the first query to a first external service in accordance with a first application programming interface;
receiving first data from the first external service in response to the first query;
generating, based on the first data, a second query and conveying the second query to a second external service in accordance with a second application programming interface;
receiving second data from the second external service in response to the second query; and
incorporating the second data into a second user interface generated and displayed on the user device.

2. The method of claim 1, further comprising:
generating a first graphical element as part of the first user interface; and
incorporating the second data into the second user interface generated on the user device in response to a user selecting the first graphical element in the first user interface.

3. The method of claim 2, further comprising:
generating a second graphical element as part of the first user interface; and
conveying a third query to the first external service in response to a user selecting the second graphical element in the first user interface, wherein the third query comprises a request for one or more modifications to the first data.

4. The method of claim 3, further comprising conveying a fourth query to the second external service in response to receiving third data, based on the third query, from the first external service.

5. The method of claim 1, further comprising managing, by the first application, a second login into the first external service and a third login into the second external service for a user of the user device based on a first login of the user into the first application.

6. The method of claim 1, wherein the first data comprises one or more tasks, and wherein the second data comprises one or more user stories.

7. The method of claim 1, wherein the first external service is an artificial intelligence chatbot, and wherein the second external service is a project management tool.

8. The method of claim 7, wherein the first data comprises one or more test scripts, and wherein the second query comprises the one or more test scripts to be executed by the project management tool.

9. The method of claim 1, wherein the first data comprises a definition of done checklist for a user story.

10. The method of claim 1, wherein the first data comprises a technical document for a user story.

11. A system, comprising:
at least one processor; and
at least one memory including program instructions which when executed by the at least one processor cause operations comprising:
receiving, by a first application, a first query from a first user interface of a user device;
conveying the first query to a first external service in accordance with a first application programming interface;
receiving first data from the first external service in response to the first query;
generating, based on the first data, a second query and conveying the second query to a second external service in accordance with a second application programming interface;
receiving second data from the second external service in response to the second query; and
incorporating the second data into a second user interface generated and displayed on the user device.

12. The system of claim 11, wherein the program instructions are further executable by the at least one processor to cause operations comprising:
generating a first graphical element as part of the first user interface; and
incorporating the second data into the second user interface generated on the user device in response to a user selecting the first graphical element in the first user interface.

13. The system of claim 12, wherein the program instructions are further executable by the at least one processor to cause operations comprising:
generating a second graphical element as part of the first user interface; and
conveying a third query to the first external service in response to a user selecting the second graphical element in the first user interface, wherein the third query comprises a request for one or more modifications to the first data.

14. The system of claim 13, wherein the program instructions are further executable by the at least one processor to cause operations comprising conveying a fourth query to the second external service in response to receiving third data, based on the third query, from the first external service.

15. The system of claim 11, wherein the program instructions are further executable by the at least one processor to cause operations comprising managing, by the first application, a second login into the first external service and a third login into the second external service for a user of the user device based on a first login of the user into the first application.

16. The system of claim 11, wherein the first data comprises one or more tasks, and wherein the second data comprises one or more user stories.

17. The system of claim 11, wherein the first external service is an artificial intelligence chatbot, and wherein the second external service is a project management tool.

18. The system of claim 17, wherein the first data comprises one or more test scripts, and wherein the second query comprises the one or more test scripts to be executed by the project management tool.

19. The system of claim 11, wherein the first data comprises a definition of done checklist for a user story.

20. A non-transitory computer readable medium storing instructions, which when executed by at least one data processor, cause operations comprising:
receiving, by a first application, a first query from a first user interface of a user device;
conveying the first query to a first external service in accordance with a first application programming interface;
receiving first data from the first external service in response to the first query;
generating, based on the first data, a second query and conveying the second query to a second external service in accordance with a second application programming interface;
receiving second data from the second external service in response to the second query; and
incorporating the second data into a second user interface generated and displayed on the user device.
